(19) United States
(12) Patent Application Publication
(10) Pub. No.: US 2026/0238293 A1
(43) Pub. Date: Aug. 13, 2026

(54) CARRIER SWITCH FOR CSI-RS RECEPTION/MEASUREMENT AND DATA RECEPTION FOR B5G/6G

(71) Applicant: MEDIATEK INC., Hsinchu City (TW)

(72) Inventors: Yi-Ju LIAO, Hsinchu City (TW); Pei-Kai LIAO, Hsinchu City (TW); Chi-Hsuan HSIEH, Hsinchu City (TW)

(73) Assignee: MEDIATEK INC., Hsinchu City (TW)

(21) Appl. No.: 19/472,943

(22) PCT Filed: Aug. 16, 2024
(86) PCT No.: PCT/CN2024/112800

§ 371 Date: Oct. 6, 2025

Related U.S. Application Data
(60) Provisional application No. 63/519,853, filed on Aug. 16, 2023.
(60) Provisional application No. 63/520,668, filed on Aug. 21, 2023.

(51) Int. Cl. H04B 7/06; H04B 17/309

(52) U.S. Cl. CPC H04B 7/0626; H04B 17/309

(57) ABSTRACT

In an aspect of the disclosure, a method, a computer-readable medium, and an apparatus are provided. The apparatus may be a UE. The UE receives an indication indicative of at least one pattern for receiving or measuring a channel state information reference signal (CSI-RS) from a base station. The UE determines, based on the indication, the at least one pattern for receiving or measuring the CSI-RS. The UE performs reception or measurement of the CSI-RS based on the at least one pattern for receiving or measuring the CSI-RS.

### CROSS-REFERENCE TO RELATED APPLICATION(S)

This application claims the benefits of U.S. Provisional Application Ser. No. 63/519,853, entitled “CARRIER SWITCH FOR CSI-RS RECEPTION/MEASUREMENT AND DATA RECEPTION FOR B5G/6G” and filed on Aug. 16, 2023, and U.S. Provisional Application Ser. No. 63/520,668, entitled “ENABLE UL COVERAGE ENHANCEMENT WITH TXRU CARRIER SWITCH FOR B5G/6G” and filed on Aug. 21, 2023, both of which are expressly incorporated by reference herein in its entirety.

### BACKGROUND

### Field

The present disclosure relates generally to wireless communications, and more particularly, to techniques of carrier switch for B5G/6G in wireless communication systems.

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE receives an indication indicative of at least one pattern for receiving or measuring a channel state information reference signal (CSI-RS) from a base station. The UE determines, based on the indication, the at least one pattern for receiving or measuring the CSI-RS. The UE performs reception or measurement of the CSI-RS based on the at least one pattern for receiving or measuring the CSI-RS.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram 700 illustrating a wireless communication system.

FIG. 8 is a diagram 800 illustrating an improved result of an agile carrier switch.

FIG. 9 illustrates a diagram depicting an example of the semi-static switch pattern for CSI-RS reception/measurement.

FIG. 10 illustrates a flow chart of a process for reception or measurement of a CSI-RS.

FIG. 11 illustrates a diagram depicting an example of the JCE period.

FIG. 12 illustrates a diagram depicting an example of restarting DMRS bundling upon carrier switch.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

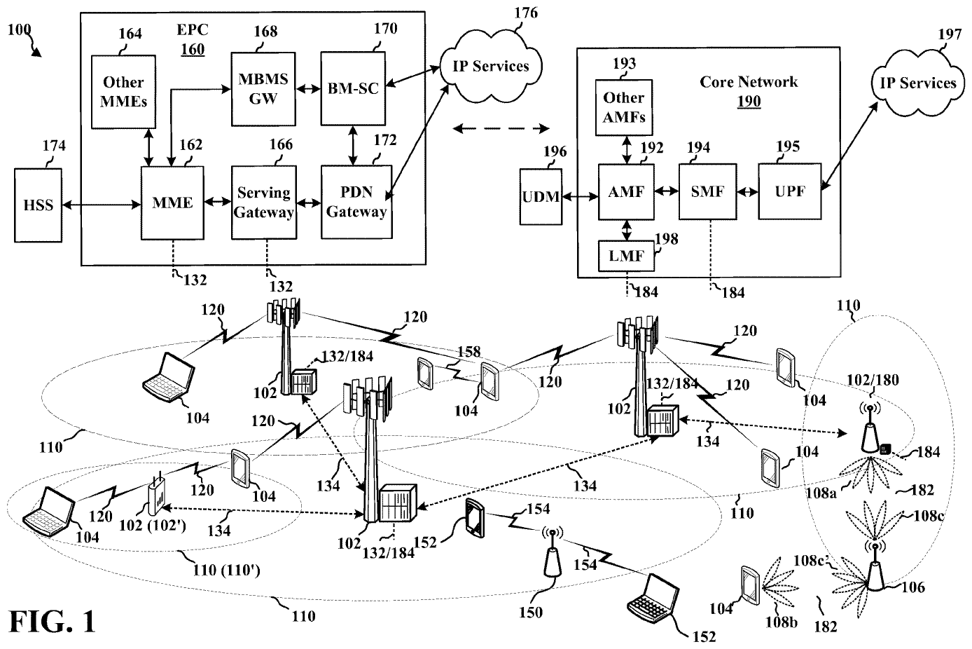

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHZ unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mm W frequencies, the gNB 180 may be referred to as an mm W base station. Extremely high frequency (EHF) is part of the RF in the electromagnetic spectrum. EHF has a range of 30 GHZ to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHZ and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

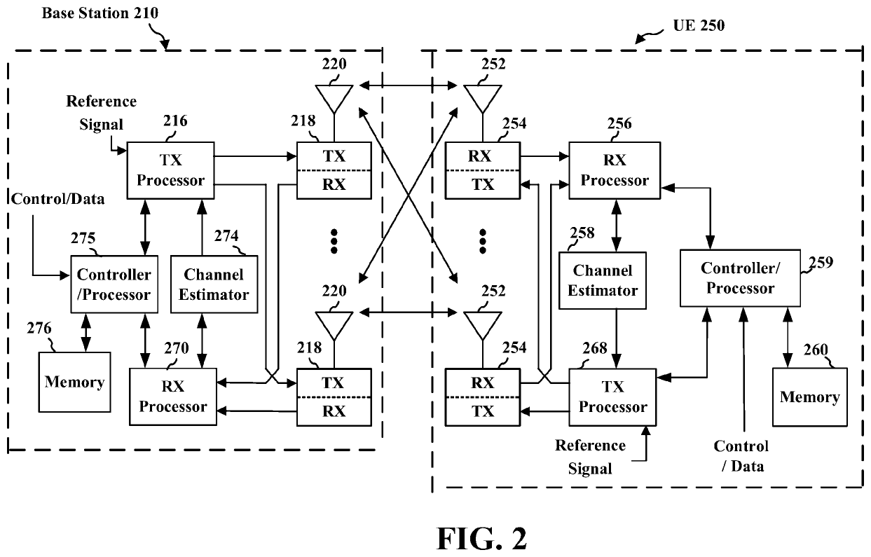

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

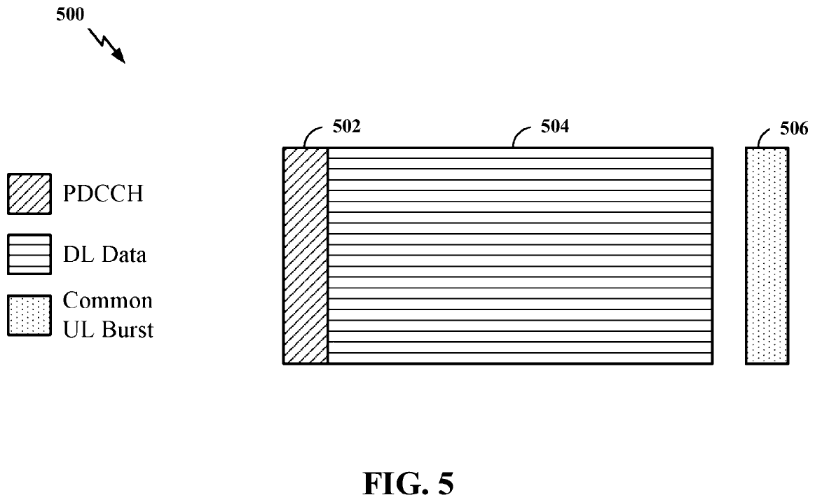

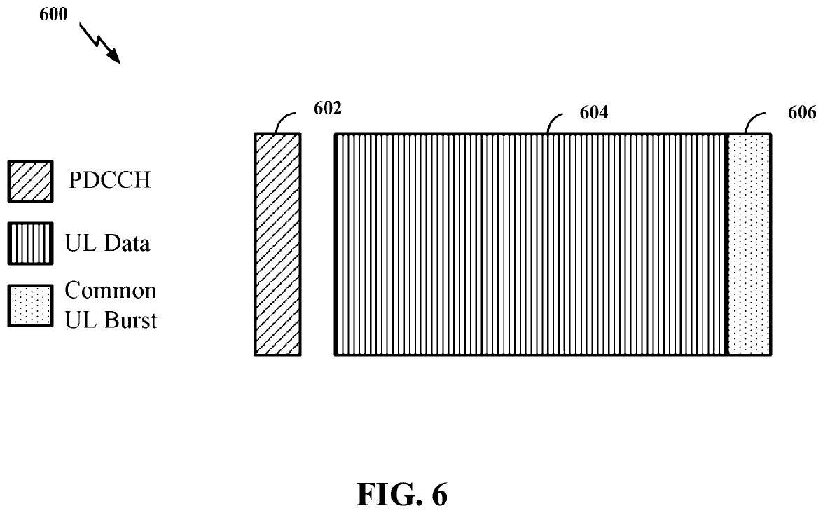

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

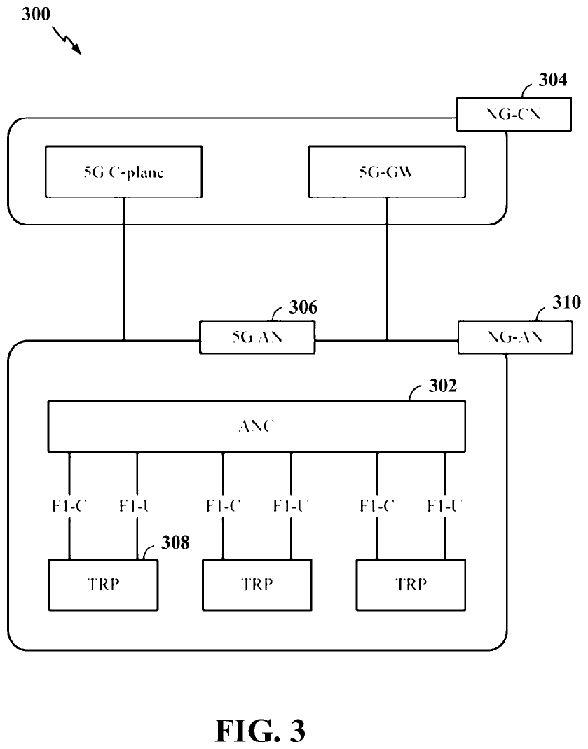

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.” The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

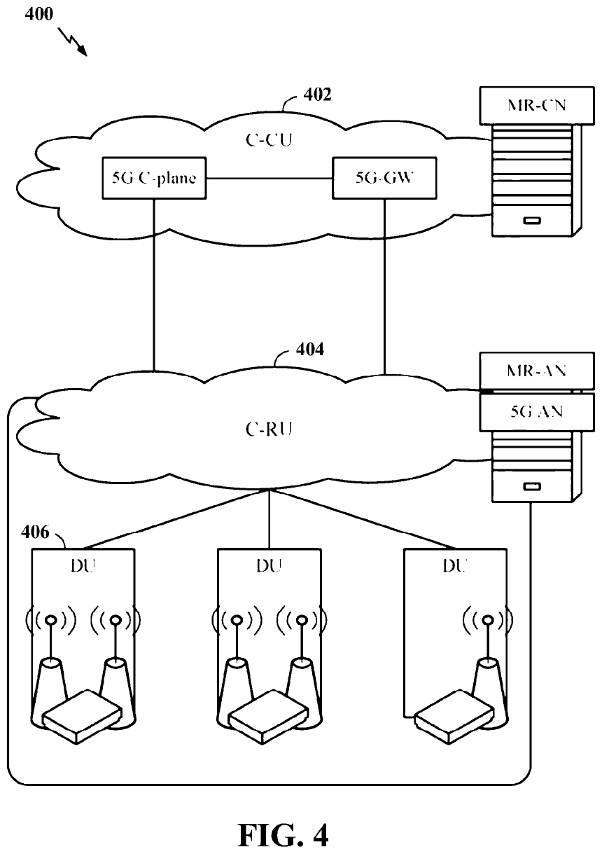

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

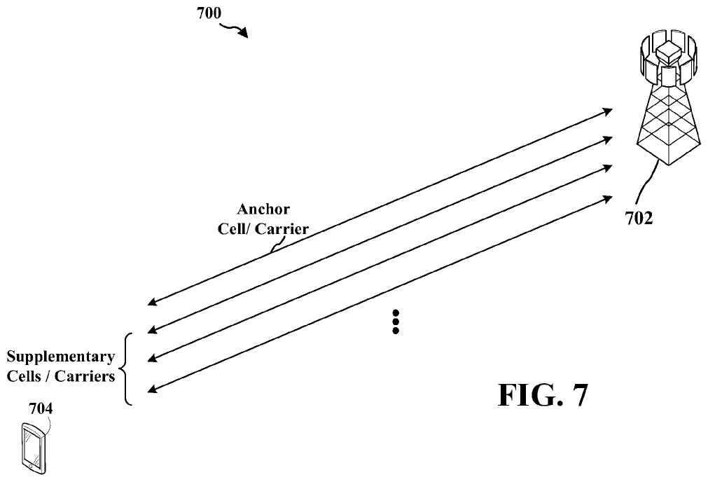

FIG. 7 is a diagram 700 illustrating a wireless communication system including a base station 702 and a UE 704. The wireless communication system implements an advanced carrier switch mechanism to optimize resource utilization between the base station 702 and the UE 704. This mechanism allows for a more flexible and efficient use of carriers, addressing scenarios where the number of configured carriers can exceed the UE's capability.

In this system, the network, through Radio Resource Control (RRC) signaling, may configure a set of carriers for the UE 704 to use for data transmission and reception. Notably, this configuration can surpass the UE's actual capability in terms of the total number of carriers it can simultaneously utilize. For instance, the RRC might configure two 100 MHz carriers for a UE 704 that is only capable of handling one 100 MHz carrier at a time. This approach provides the network with greater flexibility in resource allocation.

Given the limitation of the UE's capability, only a subset of the configured carriers is activated at any given time for downlink (DL) or uplink (UL) transmission. The number of activated carriers remains within the UE's capability. When a carrier is activated, it becomes available for both DL reception and UL transmission for the duration it remains active.

The carrier switch process refers to the dynamic changing of activated carriers for the UE 704, aiming to optimize resource utilization. Two primary mechanisms facilitate this carrier switch:
1. Semi-static pattern: This approach involves configuring the carrier switch at a higher layer, typically through RRC signaling. The pattern defines when and how carriers are to be switched and remains relatively static over a particular period. While the semi-static switch allows for predictable and efficient resource allocation, it may not be agile enough to respond to rapidly changing network conditions.
2. Dynamic indication pattern: In contrast to the semi-static pattern, this approach uses lower-layer signaling, such as Downlink Control Information (DCI) at Layer 1, to inform the UE 704 about the need for a carrier switch. This method provides greater flexibility to adapt to changing network conditions but may require more signaling overhead.

The selection between semi-static and dynamic indication patterns for carrier switch depends on specific use cases or UE capabilities. The network may also employ a combination of both approaches to achieve an optimal balance between resource utilization and flexibility.

The carrier switch process includes a switch gap. This gap facilitates a smooth transition between carriers. The UE 704 reports its capability regarding the length of the switch gap, enabling the base station 702 to set its configurations accordingly. The UE's capability report can specify whether the same switch gap length applies to both receive unit (RxU) and transmit unit (TxU) switch or if different lengths are required.

In addition to configuring the carrier switch pattern, the base station 702 may configure the specific length and timing of the switch gap through UE-specific RRC signaling. This approach allows for individual optimization of each UE based on its unique capabilities. Similar to the UE's capability report, the network may configure distinct values for RxU and TxU switch.

The implementation of carrier switch with adaptive switch gap management may enhance peak throughput by minimizing interruptions to data transmission during the switch process. By controlling the switch gap length and timing, the network can optimize the utilization of available resources, resulting in increased data rates for both DL and UL traffic.

Furthermore, the reduction in switch-related latency contributes to an overall improvement in data latency. The optimized carrier switch also allows the network to expand its coverage area and effectively offload data traffic, improving overall network performance.

This carrier switch mechanism is beneficial in scenarios with multiple Time Division Duplex (TDD) carriers with complementary configurations. For example, when one carrier is predominantly in downlink mode while another is in uplink mode, the UE 704 can switch between these carriers to maximize resource utilization. This approach prevents scenarios where UL or DL capabilities remain idle during opposing transmission modes.

The system also addresses various use cases, such as finding the best uplink or downlink scheduling opportunities, managing carrier load balancing, adapting to interference levels, and achieving MIMO gains. This flexibility marks a significant advancement over previous NR systems, where carrier switching was primarily limited to uplink transmissions for MIMO purposes.

In practice, the base station 702 may configure multiple carriers within a single cell, with one designated as the anchor carrier and others as supplementary carriers. The UE 704 can then switch between these carriers based on the configured patterns or dynamic indications. This setup allows for more efficient use of the UE's capabilities, as it can adapt to changing network conditions and requirements without being constrained by a fixed carrier assignment.

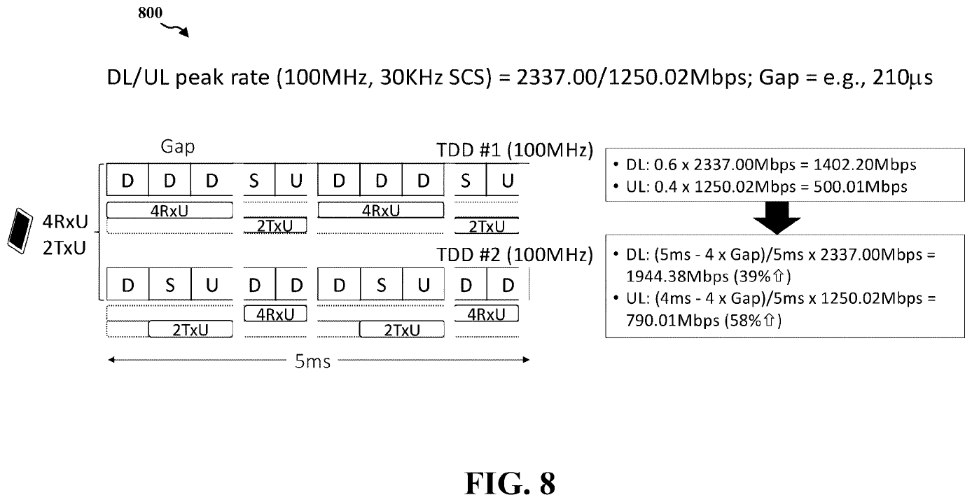

FIG. 8 is a diagram 800 illustrating an improved result of an agile carrier switch. In the illustrated scenario, when one carrier (e.g., TDD #1) is predominantly in the downlink mode, the other (e.g., TDD #2) is largely in the uplink mode. This complementary arrangement presents an opportunity for optimizing resource usage through carrier switching. Consider a UE 704 equipped with four receive units (RxUs) and two transmit units (TxUs). Without the ability to switch between carriers, the UE 704 would be confined to operate within a single TDD carrier. Consequently, during downlink slots, the UE's uplink capability would remain idle, and conversely, during uplink slots, the UE's downlink capabilities would be underutilized.

The agile carrier switch mechanism addresses this inefficiency by enabling the UE 704 to switch between carriers dynamically. This capability allows the UE 704 to optimally utilize both downlink and uplink slots across different carriers, thereby maximizing throughput gains. The base station 702 can leverage this flexibility to find the optimal scheduling opportunity for uplink or downlink transmissions, potentially based on current loading conditions.

Furthermore, the carrier switch mechanism facilitates more sophisticated network management strategies. For instance, the base station 702 may initiate a switch to carriers with lower loading, effectively balancing the network traffic. Additionally, the system can adjust based on interference levels to achieve MIMO (Multiple Input Multiple Output) gains and other performance enhancements.

The wireless communication system implements two frameworks to support carrier switch functionality, enhancing the flexibility and efficiency of resource utilization between the base station 702 and the UE 704. These frameworks address scenarios where the number of configured carriers can exceed the UE's capability, allowing for more dynamic and adaptive use of network resources.

The first framework is the SUL (Supplementary Uplink)/SDL (Supplementary Downlink)-based Framework. In this approach, a single cell incorporates multiple carriers: an anchor carrier and one or more supplementary carriers. The anchor carrier serves as the initial point of access for the UE 704 during the initial access procedure. Following the establishment of the connection, supplementary carriers are added or activated through higher layer signaling. This configuration differs significantly from traditional setups, where a cell typically includes a single downlink carrier and at most two uplink carriers.

Within the SUL/SDL-based framework, the anchor carrier and supplementary carrier(s) are similar to the Primary Cell (PCell) and additional carriers, respectively. The UE 704 can perform carrier switching between these carriers within the same cell. The TxRU (transmit/receive unit) sharing occurs across all carriers within the cell, effectively creating a pool of TxRUs that can be dynamically allocated. This sharing mechanism allows for more efficient resource utilization, as the UE 704 can switch between carriers to optimize performance based on current network conditions.

However, it is important to note that the UE 704 is not expected to perform transmission or reception on a carrier without available TxU (transmit unit) or RxU (receive unit) resources. This constraint helps maintain the integrity of the communication and prevents attempts to utilize unavailable resources.

The second framework is the CA (Carrier Aggregation)-based Framework. This approach involves an anchor cell, which functions similarly to a Primary Cell (PCell), and one or more supplementary cells, akin to Secondary Cells (SCells). As with the SUL/SDL-based framework, the anchor cell is the initial point of access for the UE 704, while supplementary cells are added or activated via higher layer signaling after the connection is established.

In the CA-based framework, TxRU sharing occurs across cells, not just within a single cell. This allows for even greater flexibility in resource allocation, as the UE 704 can switch between different cells to optimize resource utilization. However, similar to the SUL/SDL-based framework, the UE 704 is not expected to perform transmission or reception on a cell without available TxU or RxU resources.

While multiple cells may be configured, the actual number of active cells at any given time is limited by the UE's capability. This constraint necessitates intelligent management of cell activation and switching to maximize performance within the UE's limitations.

The acquisition of Channel State Information (CSI) presents unique challenges, particularly for supplementary carriers or cells. The base station 702, as illustrated in FIG. 7, configures multiple carriers for a UE 704, potentially exceeding the UE's simultaneous processing capabilities. In this context, CSI-RS reception and measurement on supplementary carriers or cells are conducted when receive units (RxUs) and transmit units (TxUs) are available on the respective carrier or cell. The UE 704 is not expected to concurrently receive data on one carrier while performing CSI-RS reception or measurement on another if such an operation surpasses its RxU capacity.

A challenge arises when the UE 704 lacks sufficient capability to support the acquisition of all CSI-RS information during carrier switching across multiple carriers. Consequently, the UE 704 may be unable to perform CSI-RS reception or measurement on specific carriers that are switched during the carrier switch process. This limitation necessitates solutions to define the timing for CSI-RS reception and measurement, as well as to consider the implementation of additional switching patterns for effective CSI-RS management across various carriers.

To address these challenges, the wireless communication system may adopt at least one of the below two solutions.

1. Measurement Gap Approach: In this solution, the base station 702 configures designated time periods known as measurement gaps for CSI-RS reception and measurement. These gaps are established through higher-layer signaling, typically via UE-specific Radio Resource Control (RRC). During these measurement gaps, the UE 704 focuses exclusively on CSI-RS measurement activities.

The measurement gap may be common to all carriers, allowing the UE 704 to measure CSI-RS on multiple carriers within a single gap period. For instance, if a 5-millisecond gap is configured, the base station 702 should provide CSI-RS resources for all relevant carriers within this timeframe. This approach offers reliability and predictability, as the network maintains precise control over the timing and duration of CSI-RS measurements.

During the measurement gap, the UE 704 does not expect to receive downlink data or transmit uplink data on any carriers or cells that might be interrupted by the measurement gap. This interruption in data communication inevitably leads to a degradation in overall data throughput, as time allocated for measurements reduces the time available for data transmission.

2. Semi-Static Pattern Approach:

The second solution introduces a more dynamic and flexible method for CSI-RS reception and measurement. In this approach, the base station 702 configures an additional semi-static pattern specifically for CSI-RS activities, separate from the carrier switch pattern used for uplink and downlink transmission. This CSI-RS-specific pattern is also configured through higher-layer signaling, typically via UE-specific RRC.

The semi-static pattern defines a schedule for the UE 704 to switch between carriers for CSI-RS reception and measurement. It allows the UE 704 to perform data reception or transmission on the same carrier during different slots when receiving and measuring CSI-RS. Furthermore, the UE 704 can engage in data communication on other carriers if there are available RxUs or TxUs on those carriers.

This solution effectively creates two parallel patterns for the UE 704: one managing data communication across anchor and supplementary carriers, and another specifically for CSI-RS reception and measurement. These patterns may overlap or be staggered, allowing the UE 704 to optimize its resource utilization. For example, the UE 704 might perform CSI-RS-related tasks on one carrier while simultaneously engaging in data communication on another, thereby maximizing network throughput and minimizing latency.

In both approaches, the UE 704 may report its capabilities regarding carrier switching and gap requirements to the base station 702. This information allows the network to optimize its configuration of measurement gaps or semi-static patterns, tailoring them to the specific capabilities of each UE 704.

Further, to optimize the CSI-RS reception and measurement process, there are two primary options for semi-static pattern design.

The first option involves repurposing legacy CSI-RS resources as a switch pattern. In this approach, the UE 704 determines when to switch its receive units (RxUs) to a specific carrier based on the configured CSI-RS resources. These CSI-RS resources may be periodic or semi-periodic (also known as semi-persistent). The temporal location of these resources serves as a trigger for the UE 704 to switch carriers for CSI-RS measurement.

This option uses existing CSI-RS configurations, potentially simplifying implementation. However, it requires coordination by the base station 702 to prevent temporal overlaps of CSI-RS resources across different carriers or cells. For instance, if the system utilizes two carriers, the base station 702 configures them such that the CSI-RS resources of these carriers do not coincide in time. This coordination allows the UE 704 to measure CSI-RS on all relevant carriers effectively.

The second option introduces a more flexible approach where the base station 702 configures a dedicated semi-static switch pattern specifically for CSI-RS reception and measurement. This pattern explicitly indicates the timing of carrier switches and the target carrier to which the UE 704 should switch its RxUs for CSI-RS resource reception and measurement.

In scenarios where the base station 702 configures multiple semi-static switch patterns, it can employ Layer 1 (L1) signaling mechanisms such as Medium Access Control (MAC) Control Elements (CEs) or Downlink Control Information (DCI) to dynamically activate the desired pattern. This flexibility allows the system to adapt to changing network conditions or measurement requirements.

The configured switch pattern operates on a repeating cycle with a predefined periodicity. For example, if the base station 702 sets a periodicity of 10 milliseconds for a switch pattern that spans 5 milliseconds, the pattern will repeat twice within each cycle. This repetition enables predictable and efficient scheduling of CSI-RS measurements across multiple carriers.

The structure of the switch pattern includes two components: a slot-level RxU switch pattern and a symbol-level switch gap (or interruption time) indication. The slot-level pattern guides the UE 704 on when to switch its RxUs to specific carriers for CSI-RS reception. The symbol-level switch gap indication provides precise information about the duration and position of the switch gap or interruption time within the switching process.

To optimize the switching process, the base station 702 configures the starting time and length of the switch gap (or interruption). Complementing this, the UE 704 reports its capability regarding the maximum switch gap length (or interruption length) it can support. This exchange of information enables the base station 702 to tailor the switch patterns to the specific capabilities of each UE 704, promoting smooth and efficient operation.

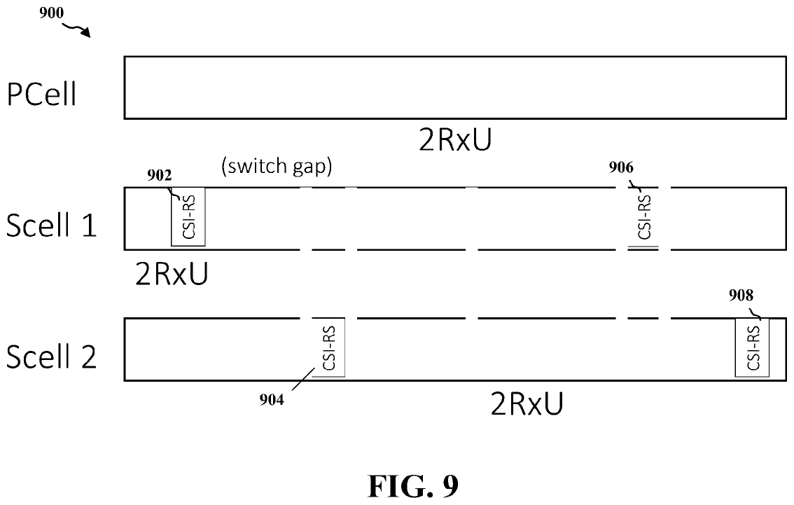

FIG. 9 is a diagram 900 illustrating an example of a semi-static switch pattern for CSI-RS reception and measurement in a carrier aggregation (CA) framework. The diagram depicts a Primary Cell (PCell) and two Supplementary Cells (SCells 1 and 2), demonstrating how carrier switching and CSI-RS measurements are managed across multiple carriers.

In this example, the PCell remains stable and does not undergo carrier switching. This configuration provides a consistent anchor point for the UE 704, maintaining essential control signaling and primary data transmission. The two SCells, labeled as SCell 1 and SCell 2, are configured to support carrier switching, allowing for dynamic resource allocation and optimized CSI-RS measurements.

The base station 702 employs a dormant Bandwidth Part (BWP) mechanism to facilitate carrier switching between the SCells for data reception. When an SCell enters a dormant BWP state, it signifies that no Receive Units (RxUs) are available on that carrier. This approach effectively implements the switching of RxUs between carriers without the need for explicit signaling of RxU availability.

For instance, when SCell 2 is configured in a dormant BWP, it indicates that the RxUs have been switched to SCell 1. This mechanism allows the UE 704 to infer the current allocation of RxUs based on the BWP state of each SCell, simplifying the carrier switching process.

The base station 702 configures a semi-static pattern specifically for CSI-RS reception and measurement between the SCells. This pattern is represented in FIG. 9 by CSI-RS 902, 904, 906, 908 on both SCell 1 and SCell 2. These CSI-RS resources serve a dual purpose: they not only provide the necessary reference signals for channel state estimation but also act as switch triggers for the carrier switching mechanism.

The UE 704 uses the configured CSI-RS resources 902, 904, 906, 908 to determine when to switch its RxUs between the SCells. For example, when a CSI-RS resource is scheduled on SCell 1, the UE 704 ensures that its RxUs are allocated to SCell 1 for that specific time period. Similarly, when a CSI-RS resource is scheduled on SCell 2, the UE 704 switches its RxUs to SCell 2.

While the CSI-RS resources trigger the carrier switches, the actual switching process includes a switch gap, which occurs between the CSI-RS resources of different SCells. This gap allows the UE 704 to reconfigure its RxUs and prepare for reception on the new carrier.

In this example, two Receive Units are allocated to each SCell when it is active. This configuration demonstrates how the UE 704 can fully utilize its available RxUs across multiple carriers through the carrier switching mechanism.

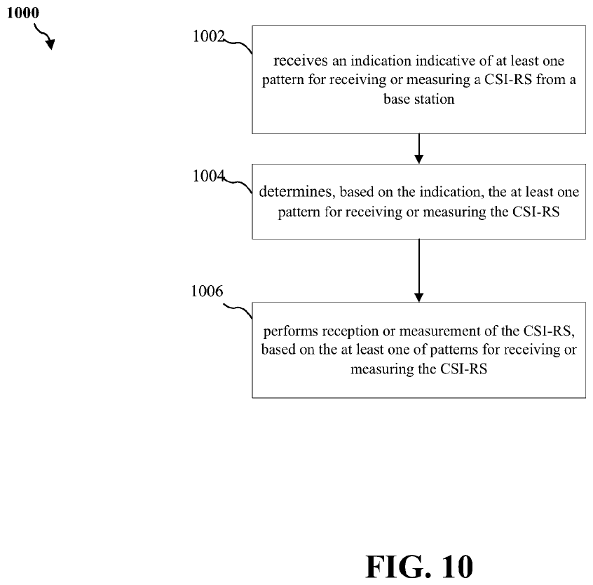

FIG. 10 illustrates a flow chart 1000 of a process for reception or measurement of a CSI-RS. This process involves interactions between a network (NW) and a UE (e.g., the UE 704) through a base station (e.g., the base station 702).

At block 1002, the UE 704 receives an indication indicative of at least one pattern for receiving or measuring a CSI-RS from a base station 702. This indication may optimize the CSI-RS reception and measurement process, as it instructs the UE 704 how to perform its tasks for the CSI-RS reception and measurement process.

At block 1004, the UE 704 determines, based on the indication, the at least one pattern for receiving or measuring the CSI-RS. The patterns for receiving or measuring the CSI-RS, for example, include a pattern of performing the reception or measurement of the CSI-RS on at least one available carrier within a measurement gap. The term “available carrier” refers to a carrier on which it has the available TxU/RxU for transmission or reception in this disclosure. In some embodiments, the measurement gap may be configured via a UE-specific radio resource control (RRC) signaling.

The patterns for receiving or measuring the CSI-RS may also include a semi-static pattern indicating the reception or measurement of the CSI-RS and reception or transmission of data on an available carrier or across multiple available carriers. It is noted that multiple available carriers may be located within a single cell or distributed across multiple cells. In the latter case, referring to “multiple available carriers” may mean they are distributed “across multiple cells”. That is, the multiple available carriers may be distributed across multiple cells. In an embodiment, the semi-static pattern may include performing the reception or measurement of the CSI-RS on an available carrier during a slot and performing reception or transmission of data on the available carrier during the same slot or a different slot. Notably, in the same slot, the resources which is not used for CSI-RS can be used for data transmission. In another embodiment, the semi-static pattern may include performing the reception or measurement of the CSI-RS on an available carrier and performing reception or transmission of data on another available carrier.

Furthermore, the semi-static pattern may utilize at least one carrier switch pattern to cause the UE 704 to switch between the multiple available carriers. In an embodiment, the at least one carrier switch pattern may include: determining, by the UE 704, the timing of carrier switch based on a CSI-RS resource configured on the multiple available carriers. In some embodiments, the CSI-RS resource may be a periodic or semi-periodic CSI-RS resource. Furthermore, time-related features of CSI-RS resources on different available carriers may be coordinated to avoid temporal overlapping. In some embodiments, the time-related features may include a periodicity or a time offset of the CSI-RS resources.

In another embodiment, the at least one carrier switch pattern may include multiple carrier switch patterns, and an activated carrier switch pattern of the multiple carrier switch patterns is indicated via a L1 signaling. The L1 signaling, for example, includes a MAC CE or DCI.

In yet another embodiment, the at least one carrier switch pattern may include: determining, by the UE 704, the timing of carrier switch and a target carrier for the reception or measurement of the CSI-RS based on a dedicated semi-static switch pattern. The dedicated semi-static switch pattern may be repeated with a configured periodicity. In some embodiments, the dedicated semi-static switch pattern may include a slot-level receive DL carrier switch pattern and a symbol-level switch gap indication. The symbol-level switch gap indication, for example, may indicate a starting time of a switch gap and a length of the switch gap. The length of the switch gap may be configured from the base station based on a capability report of the UE 704.

Following the determination of the patterns for receiving or measuring the CSI-RS, at block 1006, the UE 704 performs reception or measurement of the CSI-RS, based on the at least one of patterns for receiving or measuring the CSI-RS, in turn enabling the acquisition of CSI.

While some solutions have been introduced for conducting CSI-RS reception and measurement to improve DL performance, certain features have also been introduced to enhance UL coverage. One such feature is Joint Channel Estimation (JCE) over multiple slots, which enables the network to leverage information from multiple Demodulation Reference Signals (DMRS) symbols within the Physical Uplink Shared Channel (PUSCH) to enhance the accuracy of channel estimation.

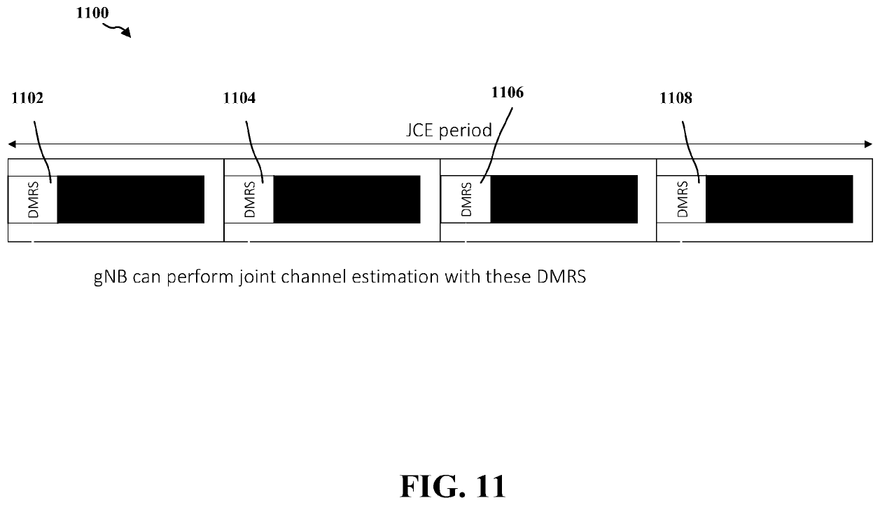

FIG. 11 illustrates a diagram 1100 depicting an example of a JCE period. The design of JCE relies on the ability to maintain certain characteristics, like phase continuity and power consistency, within the JCE period across the DMRS symbols (1102, 1104, 1106, 1108) used for PUSCH. If these conditions are met, the network can then utilize these DMRS symbols (1102, 1104, 1106, 1108) in a joint manner to refine its channel estimation across these bundled DMRS to reduce channel estimation (CE) errors, leading to improved reception quality and potentially extended coverage. That is, to enable JCE, the UE 704 has to maintain phase continuity and power consistency over the JCE period. However, in scenarios where the UE 704 is instructed to switch between carriers, the continuity of these DMRS properties might be compromised, necessitating adjustments in the UE's behavior or the JCE process itself to maintain the benefits of JCE.

The UE's ability to uphold these conditions is constrained by its capabilities. Specifically, the UE 704 may inform the network of the maximum duration within which it can maintain both power consistency and phase continuity. This information is helpful for the network to configure an appropriate Time Domain Window (TDW), also referred to as Transmission Time Window Length (TTWL) in some contexts, for JCE purposes.

In practice, due to various factors such as time-division duplexing (TDD) patterns, varying uplink and downlink slot configurations, or other potential interference effects, the UE 704 might not be able to maintain phase continuity and power consistency throughout the entire configured TDW. To address this, the concept of an actual TDW is introduced.

The actual TTW represents the actual duration within the configured TDW where the UE 704 can reliably maintain the necessary conditions for JCE. The start of the first actual TTW coincides with the first symbol of the first PUSCH transmission in an available slot within the configured TDW. The end of the actual TTW, however, can vary based on two primary scenarios:

Natural Termination: If the actual TTW naturally extends until the last symbol of the last PUSCH transmission within the configured TDW without encountering any disruptions, then the end of the actual TTW coincides with the last symbol of the last PUSCH transmission in an available slot.

Event-Triggered Termination: If an event occurs that violates the UE's ability to maintain power consistency or phase continuity. the actual TTW is truncated at the last symbol of the PUSCH transmission immediately preceding this event, provided that the transmission falls within an available slot. This mechanism ensures that only those DMRS within the actual TTW, where the UE 704 can reliably maintain the required conditions, are used for JCE.

The issue at hand involves ensuring phase continuity and power consistency in JCE when a carrier switch occurs within the configured TDW. For instance, due to the carrier switch, these continuities cannot be maintained, which leads to potential performance degradation. To address this issue, three possible solutions are proposed:

### Option 1: Exclusion of Concurrent Configuration

In this option, the JCE over multiple slots cannot be configured with TxRU carrier switch simultaneously. This means that when a carrier switch is planned, the JCE over multiple slots should not be enabled.

### Option 2: Cancellation of Carrier Switch During Configured TDW

In this option, the JCE over multiple slots cannot be performed with TxRU carrier switch together. For example, during the configured TDW (or JCE period), if a carrier switch will occur, according to the switch pattern, or L1 occasion, configured or indicated by the network, the carrier switch is canceled to maintain the phase continuity and power consistency. This option ensures these continuities by avoiding carrier switches during the TDW.

### Option 3: Restarting DMRS Bundling Upon Carrier Switch

In this option, a carrier switch is treated as a new event that restarts the DMRS bundling process (i.e., determine new actual TDW). For the semi-static carrier switch, the carrier switch acts as a semi-static event to restart DMRS bundling. For the dynamically indicated carrier switch (via L1 signaling or MIMO layer adaptation), the carrier switch is a dynamic event indicated by the network to restart DMRS bundling. This approach allows for more flexible handling of the carrier switch while maintaining the phase continuity and power consistency.

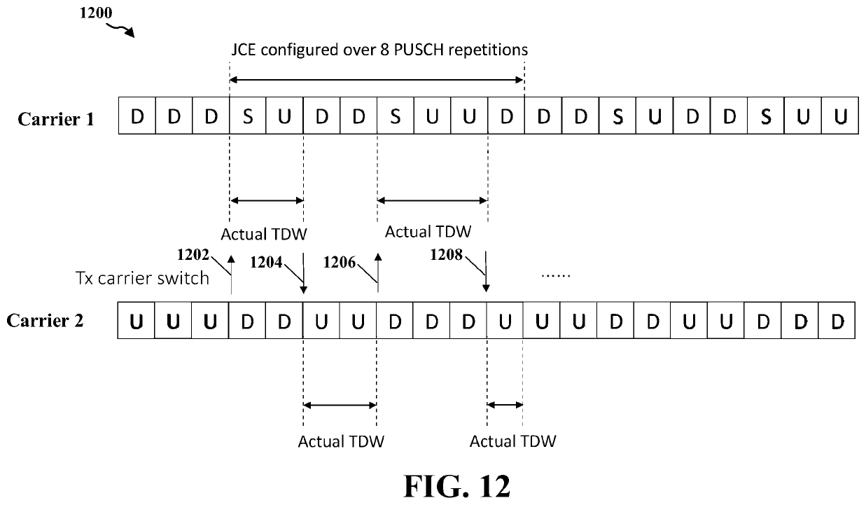

FIG. 12 illustrates a diagram 1200 depicting an example of restarting DMRS bundling upon carrier switch. This example assumes that JCE over multiple slots is enabled in conjunction with PUSCH repetition. Notably, the switch gap during carrier switch is not illustrated in the figure for simplicity. Referring to FIG. 12, the length of the configured TDW is 4 slots, and two carriers are illustrated.

As shown in FIG. 12, when switch 1202 takes place, carrier 2 is switched to carrier 1. Given that the actual TDW of carrier 1 at this point is 2 slots, upon the occurrence of switch 1204, the actual TDW of carrier 2 can also be set to 2 slots. Subsequently, when switch 1206 happens, carrier 2 is once again switched to carrier 1. Considering that the actual TDW of carrier 1 has now increased to 3 slots, the actual TDW of carrier 2 upon switch 1208 will be 1 slot. This example effectively mitigates the continuity issue by treating the carrier switch as a trigger to restart the DMRS bundling process.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving an indication indicative of at least one pattern for receiving or measuring a channel state information reference signal (CSI-RS) from a base station;
determining, based on the indication, the at least one pattern for receiving or measuring the CSI-RS; and
performing reception or measurement of the CSI-RS based on the at least one pattern for receiving or measuring the CSI-RS.

2. The method of claim 1, wherein the at least one pattern for receiving or measuring the CSI-RS comprises performing the reception or measurement of the CSI-RS on at least one available carrier within a measurement gap.

3. The method of claim 2, wherein the measurement gap is configured via a UE-specific radio resource control (RRC) signaling.

4. The method of claim 1, wherein the at least one pattern for receiving or measuring the CSI-RS comprises a semi-static pattern indicating the reception or measurement of the CSI-RS and reception or transmission of data on an available carrier or across multiple available carriers.

5. The method of claim 4, wherein the semi-static pattern comprises performing the reception or measurement of the CSI-RS on an available carrier during a slot and performing reception or transmission of data on the available carrier during the same slot or a different slot.

6. The method of claim 4, wherein the semi-static pattern comprises performing the reception or measurement of the CSI-RS on an available carrier and performing reception or transmission of data on another available carrier.

7. The method of claim 4, wherein the semi-static pattern utilizes at least one carrier switch pattern to cause the UE to switch between the multiple available carriers.

8. The method of claim 7, wherein the at least one carrier switch pattern comprises the UE determining the timing of carrier switch based on a CSI-RS resource configured on the multiple available carriers.

9. The method of claim 8, wherein the CSI-RS resource is a periodic or semi-periodic CSI-RS resource.

10. The method of claim 8, wherein time-related features of CSI-RS resources on different available carriers are coordinated to avoid temporal overlapping.

11. The method of claim 10, wherein the time-related features comprise a periodicity or a time offset of the CSI-RS resources.

12. The method of claim 7, wherein the at least one carrier switch pattern comprises multiple carrier switch patterns, and an activated carrier switch pattern of the multiple carrier switch patterns is indicated via a layer one (L1) signaling.

13. The method of claim 12, wherein the L1 signaling comprises a medium access control (MAC) control element (CE) or downlink control information (DCI).

14. The method of claim 7, wherein the at least one carrier switch pattern comprises the UE determining the timing of carrier switch and a target carrier for the reception or measurement of the CSI-RS based on a dedicated semi-static switch pattern.

15. The method of claim 14, wherein the dedicated semi-static switch pattern is repeated with a configured periodicity.

16. The method of claim 14, wherein the dedicated semi-static switch pattern comprises a slot-level receive DL carrier switch pattern and a symbol-level switch gap indication.

17. The method of claim 16, wherein the symbol-level switch gap indication indicates a starting time of a switch gap and a length of the switch gap.

18. The method of claim 17, wherein the length of the switch gap is configured from the base station based on a capability report of the UE.

19. The method of claim 1, wherein the multiple available carriers are distributed across multiple cells.

20. An apparatus for wireless communication, the apparatus being a user equipment (UE), comprising:
a memory; and
at least one processor coupled to the memory and configured to:
receive an indication indicative of at least one pattern for receiving or measuring a channel state information reference signal (CSI-RS) from a base station;
determine, based on the indication, the at least one pattern for receiving or measuring the CSI-RS; and
perform reception or measurement of the CSI-RS based on the at least one pattern for receiving or measuring the CSI-RS.

21. A computer-readable medium storing computer executable code for wireless communication of a user equipment (UE), comprising code to:
receive an indication indicative of at least one pattern for receiving or measuring a channel state information reference signal (CSI-RS) from a base station;
determine, based on the indication, the at least one pattern for receiving or measuring the CSI-RS; and
perform reception or measurement of the CSI-RS based on the at least one pattern for receiving or measuring the CSI-RS.
